(19) United States
(12) Patent Application Publication
(10) Pub. No.: US 2010/0110052 A1
(43) Pub. Date: May 6, 2010

(54) INFORMATION PROCESSING APPARATUS

(75) Inventor: Masamichi TOGAWA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/482,727

(22) Filed: Jun. 11, 2009

(30) Foreign Application Priority Data
Oct. 31, 2008 (JP) P2008-281964

(51) Int. Cl. G09G 3/36; G09G 5/00

(52) U.S. Cl. 345/207; 345/102

(57) ABSTRACT

In an information processing apparatus, an open/close detecting driver detects whether the information processing apparatus is opened or closed. If the open/close detecting driver detects that the information processing apparatus is opened or closed, an open/close-event handler determines whether the information processing apparatus is in an unused state. On the basis of this determination, the open/close-event handler controls lighting of a backlight.

### BACKGROUND OF THE INVENTION

1. Field of the Invention

The present invention relates to information processing apparatuses, and particularly to an information processing apparatus such as a cellular phone capable of controlling lighting of a display (e.g., controlling a backlight).

2. Description of the Related Art

Recently, liquid crystal displays have been used as display units in cellular phones. Since a liquid crystal included in such a liquid crystal display does not emit light, it is necessary that the liquid crystal be illuminated from behind or the like in a certain way. Typically, such a liquid crystal is illuminated from behind or the like by a backlight.

A cellular phone is often carried by the user. Therefore, a liquid crystal display of the cellular phone will be used in a dark place such as in a tunnel, as well as in a bright place such as outside. There has been proposed a technique in which an illuminance sensor (optical sensor) is used to control a backlight that illuminates the backside of a liquid crystal. The illuminance sensor is capable of detecting illuminance in an environment where a cellular phone is used. With this technique, when the environment where the cellular phone is used is changed to a bright environment, intensity of the backlight that illuminates the backside of the liquid crystal is increased, whereas when the environment where the cellular phone is used is changed to a dark environment, intensity of the backlight that illuminates the backside of the liquid crystal is reduced.

According to Japanese Unexamined Patent Application Publication No. 2006-146030, examples of techniques related to such backlight control include a known technique in which, when an ambient environment is dark, levels of brightness of a liquid crystal display (LCD) backlight and a key backlight are lowered to minimum intensity levels. With the technique proposed in this document, power consumption can be reduced both in bright and dark environments.

It is possible to preset intensity of a backlight that illuminates the backside of a liquid crystal. In the case of a sliding cellular phone, when a change in the state of the cellular phone from a closed state to an open state is detected, a backlight for illuminating the backside of a liquid crystal is controlled to light up.

In the case of a sliding cellular phone, the user may unintentionally operate the opening and closing of the cellular phone. In response to such an opening/closing operation, when a change in the state of the cellular phone from a closed state to an open state is detected, a backlight for illuminating the backside of a liquid crystal may be controlled to light up (or a display operation may be performed, in the case of an organic EL device). However, if the backlight (or organic EL device) lights up every time the user unintentionally performs the opening/closing operation, current consumption associated with lighting of the backlight (or organic EL device) may increase.

### SUMMARY OF THE INVENTION

The present invention has been made in view of the circumstances described above. An object of the present invention is to provide an information processing apparatus capable of transparently reducing current consumption associated with lighting of a display.

To solve the problems described above, an information processing apparatus according to an embodiment of the present invention includes a liquid crystal display unit having at least a liquid crystal and a backlight; an open/close detecting unit configured to detect whether the information processing apparatus is opened or closed; a determining unit configured to determine, if the open/close detecting unit detects that the information processing apparatus is opened or closed, whether the information processing apparatus is in an unused state; and a lighting control unit configured to control lighting of the backlight on the basis of the determination by the determining unit.

To solve the problems described above, an information processing apparatus according to another embodiment of the present invention includes a display unit; an open/close detecting unit configured to detect whether the information processing apparatus is opened or closed; a determining unit configured to determine, if the open/close detecting unit detects that the information processing apparatus is opened or closed, whether the information processing apparatus is in an unused state; and a lighting control unit configured to control intensity of lighting of the display on the basis of the determination by the determining unit.

The present invention makes it possible to transparently reduce current consumption associated with lighting of a display.

### BRIEF DESCRIPTION OF THE DRAWINGS

FIG. 1A and FIG. 1B illustrate external configurations of a cellular phone to which an information processing apparatus according to an embodiment of the present invention is applicable.

FIG. 2A and FIG. 2B illustrate other external configurations of the cellular phone illustrated in FIG. 1A and FIG. 1B.

FIG. 3 is a block diagram illustrating an internal configuration of the cellular phone illustrated in FIG. 1A to FIG. 2B.

FIG. 4 illustrates a software configuration of a control unit for execution of a backlight control process according to an embodiment of the present invention.

FIG. 5 shows backlight intensity levels that can be set on a backlight intensity setting screen.

FIG. 6 shows an example configuration of a backlight control table stored in a storage unit.

FIG. 7 is a flowchart illustrating a backlight control process performed in the cellular phone having the configurations illustrated in FIG. 3 and FIG. 4.

### DESCRIPTION OF THE PREFERRED EMBODIMENTS

Hereinafter, embodiments of the present invention will be described with reference to the drawings.

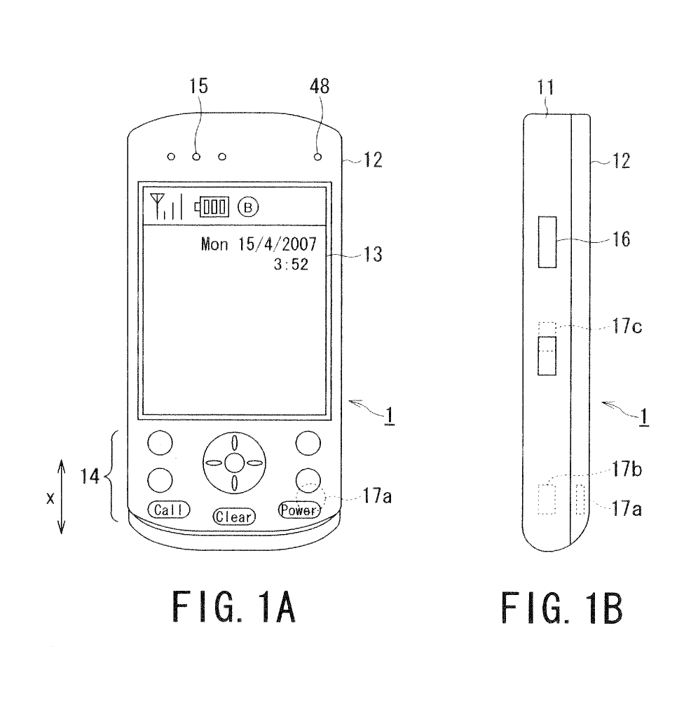

FIG. 1A and FIG. 1B illustrate external configurations of a sliding cellular phone 1 to which an information processing apparatus according to an embodiment of the present invention is applicable.

As illustrated in FIG. 1A and FIG. 1B, the cellular phone 1 includes a first housing 11 and a second housing 12, which are slidable with respect to each other through a guide unit in the direction of arrow X.

FIG. 1A is a front external view of the cellular phone 1 in which the second housing 12 is placed over the first housing 11 and held at a closed position. FIG. 1B is a side view of the cellular phone 1 illustrated in FIG. 1A.

The second housing 12 is substantially planar in shape. Referring to FIG. 1A, a main display 13, such as a liquid crystal display, is located in the center of the front side of the second housing 12. Second operation keys 14 serving as sub-operation keys are provided at the base of the front side of the second housing 12. The user can input various instructions using the second operation keys 14. The second operation keys 14 include various operation keys, such as a call key, a power key, a clear key, and an electronic mail (e-mail) key.

The second operation keys 14 further include arrow keys and an enter key. Operating the arrow keys in the up, down, left, and right directions allows the user to move the cursor in the up, down, left, and right directions. Specifically, operating the arrow keys allows the user to scroll through an address book, a list of e-mail messages, simple web pages, and images displayed on the main display 13 in the second housing 12.

Pressing the enter key allows the user to confirm various functions. For example, the user uses the arrow keys to select a desired phone number from a plurality of phone numbers listed in the address book displayed on the main display 13. If the user presses the enter key toward the inside of the second housing 12, the selected phone number is confirmed and call processing is performed on the confirmed phone number.

The second operation keys 14 further include an e-mail key to the left of the arrow keys and the enter key. Pressing the e-mail key toward the inside of the second housing 12 allows the user to call e-mail transmission/reception functions. A browser key is to the right of the arrow keys and the enter key. Pressing the browser key toward the inside of the second housing 12 allows the user to view Web page data.

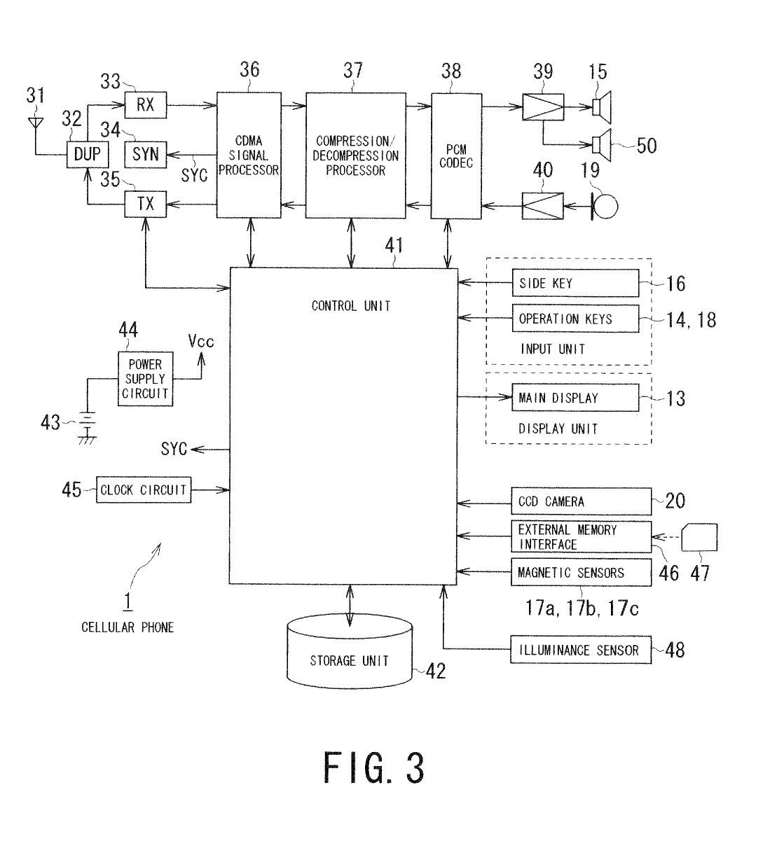

A telephone receiver 15 serving as an audio output unit is provided at a predetermined position at the top of the front side of the second housing 12 in FIG. 1A. The telephone receiver 15 allows the user to make a voice call. A speaker 50 (see FIG. 3) also serving as an audio output unit is provided at a predetermined position of the cellular phone 1. The first housing 11 is provided with a side key 16 for operating the cellular phone 1. Magnetic sensors 17a, 17b, and 17c for detecting a state of the cellular phone 1 (i.e., whether the second housing 12 is at an open position or a closed position) are provided at predetermined positions inside the first housing 11 and the second housing 12. An illuminance sensor 48 including a photodiode and a phototransistor is provided near the telephone receiver 15. The illuminance sensor 48 detects illuminance (brightness) in an environment where the cellular phone 1 is used. The main display 13 is a display such as a liquid crystal display. A liquid crystal display -typically includes such components as a liquid crystal, a backlight having a cold-cathode tube, a polarizing filter, an alignment film, electrodes, and RGB color filters. The backlight may be an edge light type backlight or a direct type backlight. The main display 13 may be an organic EL device.

The first housing 11 and the second housing 12 are provided with locking members for locking the second housing 12 at the open position and the closed position when the second housing 12 is slid through the guide unit (not shown). The positions of the locking members coincide with those of the magnetic sensors 17b and 17c. For example, the locking members are configured such that they are mechanically engaged with each other. If a force greater than or equal to a predetermined reference value is applied to the cellular phone 1 by the user in a sliding operation, the engaged locking members are brought out of engagement and become easily slidable.

A transmission/reception antenna (e.g., an antenna 31 (described below) illustrated in FIG. 3) is provided at a predetermined position inside the cellular phone 1. The transmission/reception antenna transmits and receives radio waves to and from a base station via an internal antenna.

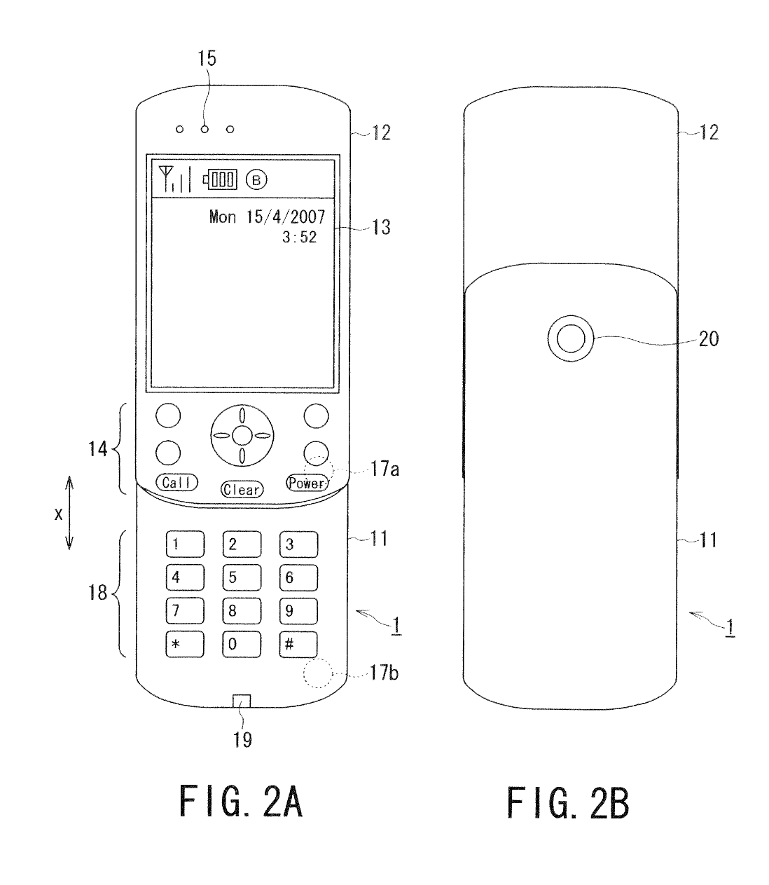

FIG. 2A and FIG. 2B illustrate other external configurations of the cellular phone 1.

FIG. 2A is a front external view of the cellular phone 1 in a state where the second housing 12 is slid upward in the long axis direction (X direction) and locked at the open position. FIG. 2B is a rear view of the cellular phone 1 illustrated in FIG. 2A.

The first housing 11 has substantially the same planar shape as that of the second housing 12. Referring to FIG. 2A, first operation keys 18 serving as main operation keys are provided at the base of the front side of the first housing 11. The user can input various instructions using the first operation keys 18. The first operation keys 18 include numeric keys “0” to “9”.

The first housing 11 is provided with a microphone 19 below the first operation keys 18. The microphone 19 collects user's voice during a call.

A battery pack is attached to the backside of the first housing 11. If the power key is turned on, power supplied from the battery pack to each circuit brings the cellular phone 1 into an operable state.

As illustrated in FIG. 2B, a CCD camera 20 is provided on the rear surface of the first housing 11. With the CCD camera 20, the user can pick up an image of a desired object.

FIG. 3 illustrates an internal configuration of the cellular phone 1. A radio signal transmitted from a base station is received by the antenna 31, and thereafter input to a receiving circuit (RX) 33 via an antenna duplexer (DUP) 32. The receiving circuit 33 may perform mixing of the received radio signal with a local oscillation signal output from a frequency synthesizer (SYN) 34 to down-convert the received signal into an intermediate frequency signal. The receiving unit 33 generates a reception baseband signal by performing demodulation (quadrature detection) on the down-converted intermediate frequency signal. The receiving unit 33 outputs the generated baseband signal to a CDMA signal processor 36. The frequency of the local oscillation signal generated by the frequency synthesizer 34 is indicated by a control signal SYC output from a control unit 41.

The CDMA signal processor 36 has a RAKE receiver. The RAKE receiver de-spreads each of a plurality of paths included in the reception baseband signal with the respective codes (that is, the same spread code as the spread code of the reception signal). After the phase in the de-spread signal of the respective paths is adjusted, the de-spread signals of the respective paths are coherently RAKE-combined by the RAKE receiver. A data series obtained by the coherent RAKE combining is subjected to de-interleaving, channel decoding (error correction decoding), and binary data determination. Thus, reception packet data in a predetermined transmission format can be obtained. The reception packet data is input to a compression/decompression processor 37.

The compression/decompression processor 37 is composed of a digital signal processor (DSP). The compression/decompression processor 37 separates the reception packet data output from the CDMA signal processor 36 for each medium with a multiplexer/demultiplexer, and decodes the separated data for each medium. In a call mode, the compression/decompression processor 37 decodes speech data corresponding to spoken voice included in the reception packet data with a speech codec. If moving image data is included in the reception packet data, such as in the case of a videophone mode, the compression/decompression processor 37 decodes the moving image data with a video codec. If the reception packet data is downloaded content, the compression/decompression processor 37 decompresses the downloaded content and outputs the decompressed downloaded content to the control unit 41.

A digital speech signal obtained by decoding is supplied to a PCM codec 38. The PCM codec 38 PCM-decodes the digital speech signal output from the compression/decompression processor 37, and outputs the resulting analog speech signal to a reception amplifier 39. The analog speech signal is amplified by the reception amplifier 39 and output from the telephone receiver 15.

The digital moving image signal decoded by the video codec in the compression/decompression processor 37 is input to the control unit 41. The control unit 41 displays a moving image based on the digital moving image signal output from the compression/decompression processor 37 on the main display 13 via a video RAM such as a VRAM. The control unit 41 may display, on the main display 13 via the video RAM, not only a moving image based on the received moving image data, but also a moving image based on moving image data picked up by the CCD camera 20.

If the reception packet data is an e-mail message, the compression/decompression processor 37 supplies the e-mail message to the controller 41. The controller 41 stores the e-mail message supplied from the compression/decompression processor 37 in a storage unit 42. Then, in response to a user's operation of the first operation keys 18 and the second operation keys 14, which are included in an input unit, the control unit 41 reads out the e-mail message stored in the storage unit 42 and displays the read-out e-mail message on the main display 13.

A speaker's (user's) voice signal (analog speech signal) input in the call mode to the microphone 19 is amplified to an appropriate level by a transmission amplifier 40 and PCM-coded by the PCM codec 38. A digital audio signal obtained by the PCM coding is input to the compression/decompression processor 37. A moving image signal output from the CCD camera 20 is digitized by the controller 41 and input to the compression/decompression processor 37. An e-mail message, which is text data generated by the controller 41, is also input to the compression/decompression processor 37.

The compression/decompression processor 37 compression-encodes the digital speech signal from the PCM codec 38 in a format corresponding to a predetermined compression data rate. Thus, speech data is generated. Also, the compression/decompression processor 37 compression-encodes the digital moving image signal output from the control unit 41 to generate moving image data. Then, the compression/decompression processor 37 multiplexes the audio data and the moving image data in a predetermined transmission format with a multiplexer/demultiplexer, packetizes the multiplexed data, and outputs the resulting transmission packet data to the CDMA signal processor 36. When an e-mail message is output from the control unit 41, the compression/decompression processor 37 also multiplexes the e-mail message into transmission packet data.

The CDMA signal processor 36 uses a spread code assigned to a transmission channel to perform spread spectrum processing on the transmission packet data output from the compression/decompression processor 37, and outputs an output signal obtained by the spread spectrum processing to a transmitting circuit (TX) 35. The transmitting circuit 35 uses a digital modulation method, such as a quadrature phase shift keying (QPSK) method, to modulate the signal obtained by the spread spectrum processing. The transmitting circuit 35 combines the transmission signal obtained by the digital modulation with a local oscillation signal generated by the frequency synthesizer 34 to frequency-convert (up-convert) the resulting signal into a radio signal. The transmitting circuit 35 high-frequency-amplifies the radio signal generated by the up-conversion to achieve a transmission power level indicated by the control unit 41. The high-frequency-amplified radio signal is supplied via the antenna duplexer 32 to the antenna 31, and transmitted from the antenna 31 to the base station.

The cellular phone 1 has an external memory interface 46. The external memory interface 46 has a slot which allows insertion and removal of a memory card 47. The memory card 47 is a flash memory card, such as a NAND flash memory card or a NOR flash memory card. Various types of data, such as image data, audio data, and music data, can be written to or read out of the memory card 47 via a 10-pin terminal.

The control unit 41 includes a central processing unit (CPU), a read only memory (ROM), and a random access memory (RAM). The CPU executes various types of processing in accordance with programs stored in the ROM or various application programs loaded from the storage unit 42 into the RAM. The CPU generates various control signals and supplies them to various parts of the cellular phone 1. Thus, the CPU performs overall control of the cellular phone 1. The RAM stores data necessary for the CPU to execute various types of processing.

The storage unit 42 is a hard disk drive (HDD) or a flash memory device, which is an electrically programmable and erasable non-volatile memory. The storage unit 42 stores various data groups and various application programs executed by the CPU in the control unit 41.

A power supply circuit 44 generates a predetermined operating power supply voltage Vcc on the basis of an output from a battery 43, and supplies the operating power supply voltage Vcc to each circuit unit. The cellular phone 1 further includes a clock circuit 45 that accurately measures the current time.

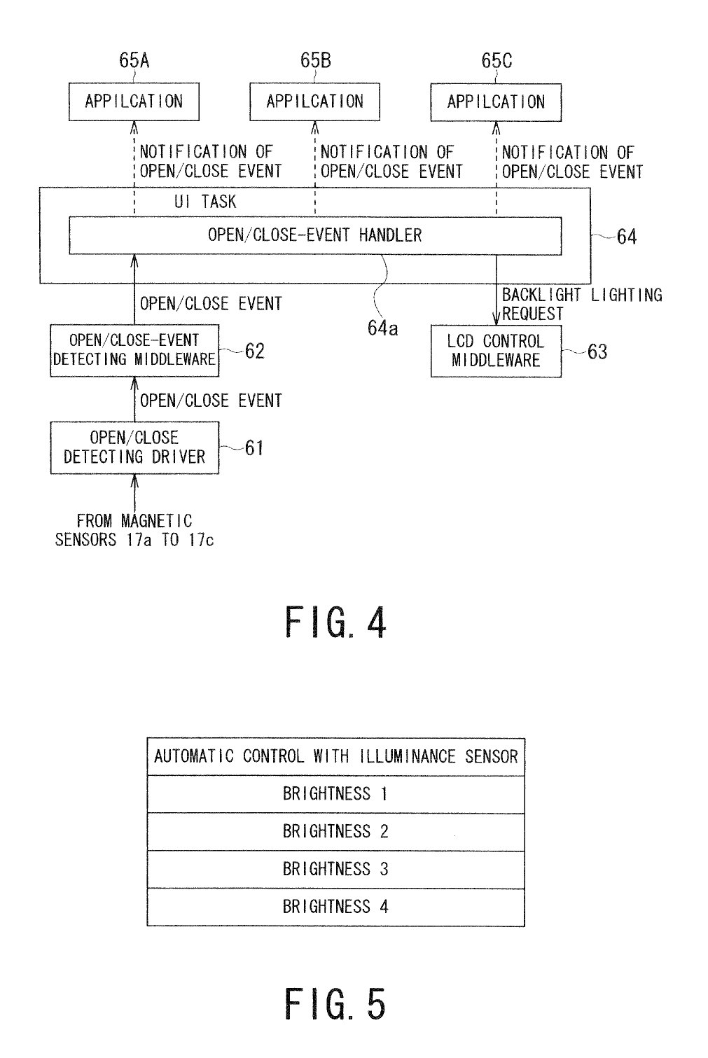

FIG. 4 illustrates a software configuration of the control unit 41 for execution of a backlight control process according to an embodiment of the present invention. If the main display 13 is an organic EL device, the concept of backlight control can be replaced with that of display intensity control for the organic EL device. A further description of the organic EL device will be given if necessary.

As illustrated in FIG. 4, an open/close detecting driver 61 detects opening and closing of the cellular phone 1 on the basis of detection signals from the magnetic sensors 17a to 17c. That is, the open/close detecting driver 61 detects that the cellular phone 1 is in a state where the second housing 12 is at the open or closed position. Upon detection of opening/closing of the cellular phone 1, the open/close detecting driver 61 generates an open/close event and transmits the generated open/close event to open/close-event detecting middleware 62. The open/close-event detecting middleware 62 receives the open/close event from the open/close detecting driver 61 and transmits the received open/close event to a UI task 64.

The UI task 64 is a module which manages UI tasks. The UI task 64 includes an open/close-event handler 64a that handles (or passes on) an open/close event. The open/close-event handler 64a receives the open/close event from the open/close-event detecting middleware 62, and handles the received open/close event to notify each of applications 65A, 65B, and 65C of the open/close event. At the same time, the open/close-event handler 64a transmits a backlight lighting request to LCD control middleware 63 which controls the main display 13. If the main display 13 is an organic EL device, the open/close-event handler 64a transmits a display lighting request to the LCD control middleware 63 which controls the main display 13.

Before an explanation of a backlight control (organic EL display control) process according to an embodiment of the present invention, preconditions of the process will be described. The cellular phone 1 can set in advance backlight intensity used when the backlight lights up, on a backlight intensity setting screen of the cellular phone 1. Specifically, as shown in FIG. 5, the cellular phone 1 can set in advance the backlight intensity to one of four levers “brightness 1” to “brightness 4”. For example, when “brightness 3” is set, the backlight always lights up at intensity corresponding to the level of “brightness 3”. Alternatively, the cellular phone 1 can select “automatic control with illuminance sensor”, which allows automatic backlight control using the illuminance sensor 48. In this case, the backlight is controlled in accordance with illuminance (brightness) in an environment where the cellular phone 1 is used, the illuminance being detected by the illuminance sensor 48. Specifically, the backlight for the main display 13 is controlled using a backlight control table stored in the storage unit 42.

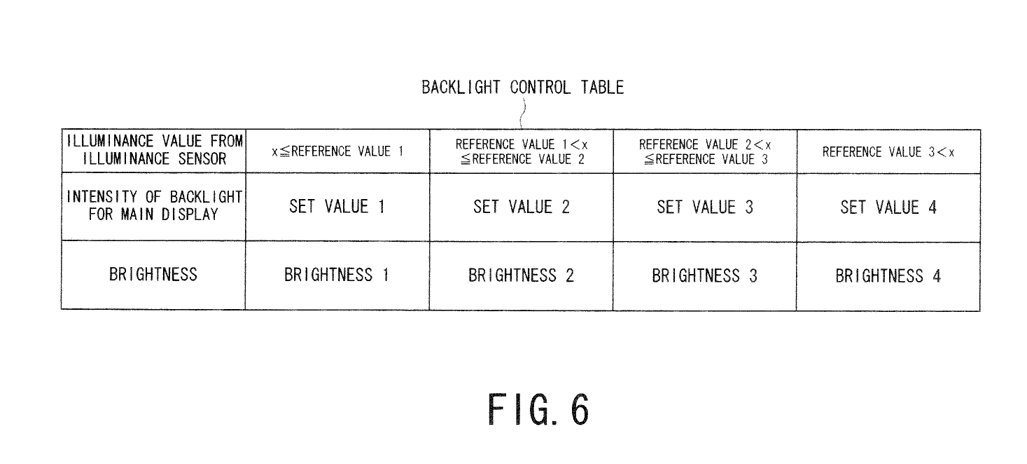

FIG. 6 shows an example configuration of a backlight control table stored in the storage unit 42. For example, as shown in FIG. 6, reference value 1 to reference value 3 (reference value 1<reference value 2<reference value 3) are set as predetermined reference values related to illuminance. If it is determined that an illuminance value read from the illuminance sensor 48 is less than or equal to reference value 1, the control unit 41 sets the intensity of the backlight for the main display 13 to set value 1 (i.e., a set value related to intensity of the backlight). If it is determined that an illuminance value read from the illuminance sensor 48 is greater than reference value 1 and less than or equal to reference value 2, the control unit 41 sets the intensity of the backlight to set value 2. If it is determined that an illuminance value read from the illuminance sensor 48 is greater than reference value 2 and less than or equal to reference value 3, the control unit 41 sets the intensity of the backlight to set value 3. If it is determined that an illuminance value read from the illuminance sensor 48 is greater than reference value 3, the control unit 41 sets the intensity of the backlight to set value 4. Here, set value 1 to set value 4 have the following relationship: set value 1<set value 2<set value 3<set value 4. Brightness indicating the level of brightness in an environment where the cellular phone 1 is used is classified as brightness 1, brightness 2, brightness 3, or brightness 4 according to the illuminance value (x≦reference value 1, reference value 1<x≦reference value 2, reference value 2<x≦reference value 3, or reference value 3<x) read from the illuminance sensor 48. There may be four or more predetermined reference values related to illuminance, so that five or more set values related to intensity of the backlight can be provided. Here, the term “intensity” refers to brightness per unit area of a light-emitting body (e.g., the backlight for the main display 13). If the main display 13 is an organic EL device, the term “intensity” refers to intensity of the organic EL device.

The cellular phone 1 performs the following control operations related to a lit state of the main display 13. That is, if the main display 13 remains in a brightly lit state (hereinafter referred to as a “fully-lit state”) for a predetermined period of time without being operated by the user, the main display 13 goes into a darker state (hereinafter referred to as a “partially-lit state”) where text and icons on the main display 13 are still identifiable. The partially-lit state is entered by reducing the light emitting intensity. Then, if the main display 13 remains in the partially-lit state for a predetermined period of time without being operated by the user, the main display 13 goes into another state (hereinafter referred to as an “unlit state”) where the main display 13 displays nothing. If the main display 13 is an organic EL device, the “fully-lit state” is a state in which the main display 13 lights up brightly (i.e., performs display at a first intensity level), and the “partially-lit state” is a state in which the main display 13 performs display at a second intensity level lower than the first intensity level.

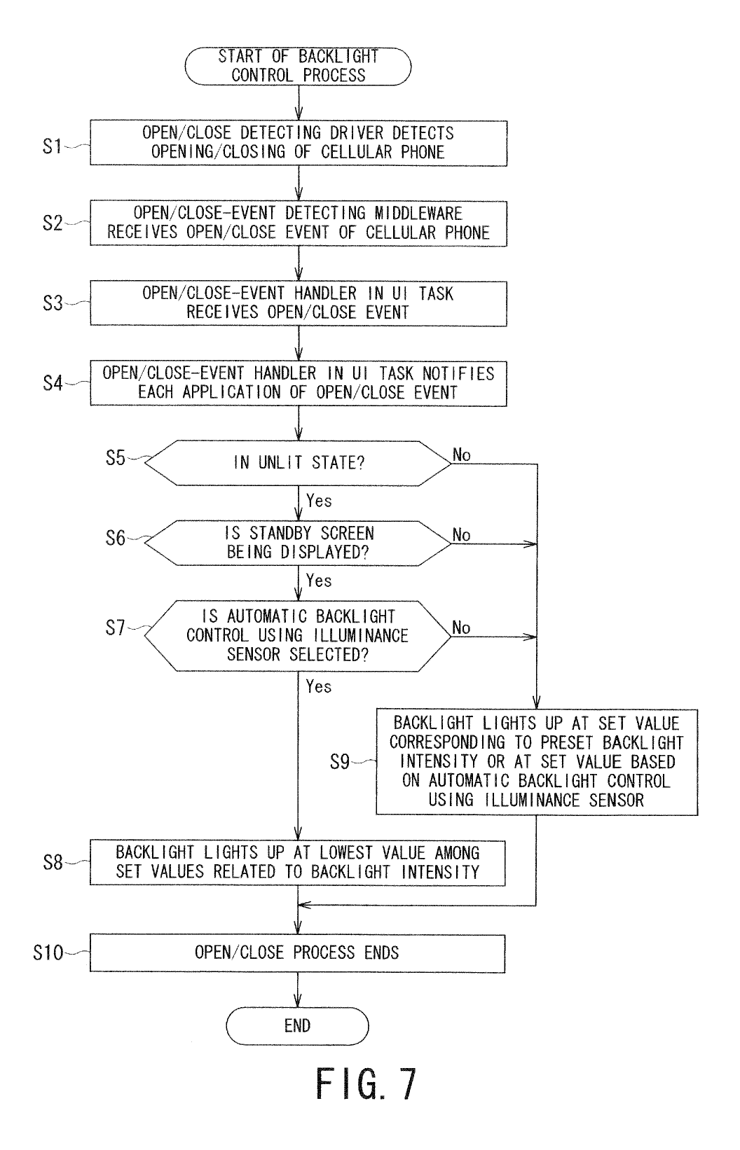

With reference to a flowchart of FIG. 7, a backlight control process performed in the cellular phone 1 having the configurations illustrated in FIG. 3 and FIG. 4 will be described. This backlight control process starts every time the open/close detecting driver 61 detects opening/closing of the cellular phone 1.

In step S1, the open/close detecting driver 61 detects opening/closing of the cellular phone 1 on the basis of detection signals from the magnetic sensors 17a to 17c. That is, the open/close detecting driver 61 detects whether the cellular phone 1 is in a state where the second housing 12 is at the open or closed position. Upon detection of the opening/closing of the cellular phone 1, the open/close detecting driver 61 generates an open/close event and transmits the generated open/close event to the open/close-event detecting middleware 62. In step S2, the open/close-event detecting middleware 62 receives the open/close event from the open/close detecting driver 61 and transmits the received open/close event to the UI task 64.

In step S3, the open/close-event handler 64a in the UI task 64 receives the open/close event from the open/close-event detecting middleware 62. In step S4, the open/close-event handler 64a handles the received open/close event to notify each of the applications 65A to 65C of the open/close event. In step S5, the open/close-event handler 64a determines whether the main display 13 is in the unlit state. If the open/close-event handler 64a determines in step S5 that the main display 13 is not in the unlit state (NO in step S5), the open/close-event handler 64a recognizes that the main display 13 is in the fully-lit state or partially-lit state, and that the user is performing certain operations or consciously opening or closing the cellular phone 1. In step S9, the open/close-event handler 64a transmits a first backlight lighting request to the LCD control middleware 63 that controls the main display 13. If backlight intensity used when the backlight lights up is set in advance on the backlight intensity setting screen, the first backlight lighting request is a request to cause the backlight to light up at a set value corresponding to the backlight intensity set in advance. Alternatively, if the automatic backlight control using the illuminance sensor 48 is selected, the first backlight lighting request is a request to cause the backlight to light up at a set value based on the automatic backlight control performed with the illuminance sensor 48.

In response to the first backlight lighting request from the open/close-event handler 64a, the LCD control middleware 63 controls the main display 13 such that the backlight lights up at a set value corresponding to preset backlight intensity or at a set value based on the automatic backlight control performed with the illuminance sensor 48. Then, the process proceeds to step S10, where the opening/closing process ends.

If the open/close-event handler 64a determines in step S5 that the main display 13 is in the unlit state (YES in step S5), the process proceeds to step S6. In step S6, the open/close-event handler 64a determines whether a standby screen is being displayed on the main display 13. Here, the term “standby screen” refers both to a standby screen displayed in response to a user's operation, and a standby screen automatically switched from the previous display screen after the previous screen is idle for a predetermined period of time.

If it is determined in step S6 that a screen other than the standby screen is being displayed on the main display 13 (NO in step S6), the open/close-event handler 64a recognizes that although the main display 13 is in the unlit state, a screen other than the standby screen is being displayed on the main display 13 and the user is consciously opening or closing the cellular phone 1. Then, in step S9, the open/close-event handler 64a transmits the first backlight lighting request to the LCD control middleware 63 that controls the main display 13. In response to the first backlight lighting request from the open/close-event handler 64a, the LCD control middleware 63 controls the main display 13 such that the backlight lights up at a set value corresponding to preset backlight intensity or at a set value based on the automatic backlight control performed with the illuminance sensor 48. Then, the process proceeds to step S10.

Thus, if the backlight already lights up and thereafter the backlight lights up again in response to opening/closing of the cellular phone 1, it is possible to prevent the situation where the backlight does not light up either at a set value based on the automatic backlight control performed with the illuminance sensor 48 or at a set value corresponding to preset backlight intensity. Therefore, it is possible to prevent a user's unintended sudden reduction in illuminance provided by lighting of the backlight.

In a case where the backlight lights up in step S9, if the backlight already lights up at a set value of the same backlight intensity, the backlight may be kept lighting up in the same state instead of being caused to light up again.

If it is determined in step S6 that the standby screen is being displayed on the main display 13 (YES in step S6), the process proceeds to step S7. In step S7, the open/close-event handler 64a determines whether the automatic backlight control using the illuminance sensor 48 is selected. If it is determined in step S7 that the automatic backlight control using the illuminance sensor 48 is not selected (i.e., it is determined that backlight intensity used when the backlight lights up is set in advance) (NO in step S7), the process proceeds to step S9. In step S9, the open/close-event handler 64a transmits the first backlight lighting request to the LCD control middleware 63 that controls the main display 13. In response to the first backlight lighting request from the open/close-event handler 64a, the LCD control middleware 63 controls the main display 13 such that the backlight lights up at a set value corresponding to preset backlight intensity. Then, the process proceeds to step S10.

Thus, even if the cellular phone 1 is opened or closed in a case where backlight intensity used when the backlight lights up is preset on the backlight intensity setting screen, the backlight can be kept lighting up at a set value corresponding to the preset backlight intensity, instead of being lit up at the lowest value among set values related to intensity of the backlight. Therefore, it is possible to reduce user complaints stating that the backlight sometimes does not light up at a set value corresponding to preset backlight intensity.

In the flowchart of FIG. 7, the order of step S5 and step S6 in the determination process may be reversed.

If it is determined in step S7 that the automatic backlight control using the illuminance sensor 48 is selected (YES in step S7), the open/close-event handler 64a recognizes that the user is unintentionally opening or closing the cellular phone 1.

In step S8, the open/close-event handler 64a transmits a second backlight lighting request to the LCD control middleware 63 that controls the main display 13. Here, the second backlight lighting request is a request to cause the backlight to light up not at a set value based on the automatic backlight control using the illuminance sensor 48, but at the lowest value (e.g., “brightness 1” in FIG. 5) among set values related to intensity of the backlight. As long as it is possible to reduce current consumption associated with lighting of the backlight, the set value used in response to the second backlight lighting request does not necessarily have to be the lowest set value, and may be another set value (e.g., “brightness 2” in FIG. 5).

In response to the second backlight lighting request from the open/close-event handler 64a, the LCD control middleware 63 controls the main display 13 such that the backlight lights up at the lowest value (e.g., “brightness 1” in FIG. 5) among set values related to intensity of the backlight. Then, the process proceeds to step S10.

In the embodiment of the present invention described above, to determine whether the user is unintentionally opening or closing the cellular phone 1, estimation as to whether the user is using the cellular phone 1 is made on the basis of whether the main display 13 is in the unlit state and whether the standby screen is being displayed. The estimation as to whether the user is using the cellular phone 1 may be made by using factors other than these two factors.

Here, a “state where the user is not using the cellular phone 1 or where the user is unintentionally using the cellular phone 1” is defined as an “unused state”, and a “state where the user is consciously using the cellular phone 1” is defined as a “used state”.

In the embodiment of the present invention described above, whether the cellular phone 1 has been opened or closed is detected. If opening or closing of the cellular phone 1 is detected, a determination as to whether the cellular phone 1 is in an unused state (i.e., in a state where the user is not using the cellular phone 1). On the basis of this determination, lighting of the backlight for the main display 13 is controlled. Specifically, if it is determined that the cellular phone 1 is in the unused state, control is performed such that the backlight lights up at a first set value related to intensity of the backlight, whereas if it is determined that the cellular phone 1 is in the used state, control is performed such that the backlight lights up at a second set value related to intensity of the backlight.

Thus, when the user is unintentionally opening or closing the cellular phone 1, current consumption of the main display 13 associated with the opening/closing of the cellular phone 1 can be transparently reduced.

Although the cellular phone 1 of sliding type has been specifically described in the foregoing embodiment, the present invention is not limited to this. For example, the present invention is also applicable to the cellular phone 1 of straight type and the cellular phone 1 of folding type.

The present invention is applicable not only to the cellular phone 1, but also to other types of information processing apparatuses, such as a personal digital assistant (PDA), a personal computer, a portable game machine, a portable sound player, and a portable video player.

The series of processes described in the embodiment of the present invention can be performed either by software or hardware.

In the embodiment of the present invention described above, the steps in the flowchart are performed sequentially in the described order. However, the steps may be performed simultaneously or individually, and do not necessarily have to be performed sequentially.

What is claimed is:

1. An information processing apparatus comprising:
a liquid crystal display unit including at least a liquid crystal and a backlight;
an open/close detecting unit configured to detect whether the information processing apparatus is opened or closed;
a determining unit configured to determine, if the open/close detecting unit detects that the information processing apparatus is opened or closed, whether the information processing apparatus is in an unused state; and
a lighting control unit configured to control lighting of the backlight on the basis of the determination by the determining unit.

2. The information processing apparatus according to claim 1, wherein, if the determining unit determines that the information processing apparatus is in an unused state, the lighting control unit controls such that the backlight lights up at a first set value related to intensity of the backlight; and
if the determining unit determines that the information processing apparatus is in a used state, the lighting control unit controls such that the backlight lights up at a second set value related to intensity of the backlight.

3. The information processing apparatus according to claim 2, wherein the first set value related to intensity of the backlight is smaller than the second set value related to intensity of the backlight.

4. The information processing apparatus according to claim 3, wherein the first set value related to intensity of the backlight is the smallest set value of set values related to intensity of the backlight.

5. The information processing apparatus according to claim 3, wherein the second set value related to intensity of the backlight is a fixed value related to intensity of the backlight.

6. The information processing apparatus according to claim 2, further comprising:
a detecting unit configured to detect illuminance in an environment where the information processing apparatus is used; and
a setting unit configured to set intensity of the backlight that lights up if the liquid crystal display unit displays an image to one of a plurality of set values, on the basis of an illuminance value detected by the detecting unit, with reference to a control table in which brightness regions corresponding to illuminance values and set values related to intensity of the backlight are associated with each other and registered in advance,
wherein if the determining unit determines that the information processing apparatus is in an unused state, the lighting control unit controls such that the backlight lights up at the first set value related to intensity of the backlight, not at the set value set by the setting unit.

7. The information processing apparatus according to claim 6, wherein if the determining unit determines that the information processing apparatus is in a used state, the lighting control unit controls such that the backlight lights up at the set value set by the setting unit, the set value being the second set value.

8. The information processing apparatus according to claim 1, wherein the information processing apparatus is a cellular phone having a sliding structure.

9. The information processing apparatus according to claim 1, wherein the unused state of the information processing apparatus includes at least an unlit state and a state in which a standby screen is being displayed.

10. The information processing apparatus according to claim 9, wherein the unlit state is a state in which the liquid crystal display unit does not display an image.

11. An information processing apparatus comprising:
a display unit;
an open/close detecting unit configured to detect whether the information processing apparatus is opened or closed;
a determining unit configured to determine, if the open/close detecting unit detects that the information processing apparatus is opened or closed, whether the information processing apparatus is in an unused state; and
a lighting control unit configured to control intensity of lighting of the display unit on the basis of the determination by the determining unit.

12. The information processing apparatus according to claim 11, wherein, if the determining unit determines that the information processing apparatus is in an unused state, the lighting control unit controls such that the display unit lights up at a first set value related to intensity of the display unit; and
if the determining unit determines that the information processing apparatus is in a used state, the lighting control unit controls such that the display unit lights up at a second set value related to intensity of the display unit.

13. The information processing apparatus according to claim 12, wherein the first set value related to intensity of the display unit is smaller than the second set value related to intensity of the display unit.

14. The information processing apparatus according to claim 13, wherein the first set value related to intensity of the display unit is the smallest set value of set values related to intensity of the display unit.

15. The information processing apparatus according to claim 13, wherein the second set value related to intensity of the display unit is a fixed value related to intensity of the display unit.

16. The information processing apparatus according to claim 11, wherein the information processing apparatus is a cellular phone having a sliding structure.

17. The information processing apparatus according to claim 11, wherein the unused state of the information processing apparatus includes at least an unlit state and a state in which a standby screen is being displayed.

18. The information processing apparatus according to claim 17, wherein the unlit state is a state in which the display unit does not display an image.

19. The information processing apparatus according to claim 11, wherein the display unit includes a liquid crystal display unit including at least a liquid crystal and a backlight, and a display unit including an organic EL device.
